(19) United States
(12) Patent Application Publication
(10) Pub. No.: US 2026/0235282 A1
(43) Pub. Date: Aug. 13, 2026

(54) INTERCHANGEABLE TRACK LIGHT CONNECTOR/ADAPTER THAT FITS TO VARIOUS SINGLE-CIRCUIT TRACK SYSTEMS

(71) Applicant: Up-shine Lighting Co., Limited, Shenzhen (CN)

(72) Inventors: Guoliang Li, Shenzhen (CN); Zuhua Xie, Shenzhen (CN); Haibo Dai, Shenzhen (CN); Xiaobing Wei, Shenzhen (CN); Lequn Li, Shenzhen (CN)

(21) Appl. No.: 19/207,424

(22) Filed: May 14, 2025

(30) Foreign Application Priority Data
Feb. 10, 2025 (CN) 202510147080.1

(51) Int. Cl. F21V 23/06; F21S 8/06; F21V 21/35; F21Y 115/10; H01R 25/14

(52) U.S. Cl. CPC F21V 23/06; F21S 8/066; F21V 21/35; H01R 25/142; F21Y 2115/10

(57) ABSTRACT

The present invention discloses an interchangeable track light connector/adapter that fits to various single-circuit track systems including a connector/adapter, and grooves opened on inner walls of the connector/adapter. Two sets of positioning block adaptable to multiple sets of track adapter are mounted to the grooves of the connector/adapter. A lighting mechanism is mounted at a bottom end of each of the multiple sets of track adapter. By pushing an L-type connector, a J-type connector and an H-type connector, the L-type connector, the J-type connector and the H-type connector are slidably connected to the grooves between the two sets of positioning block respectively, so that the connector/adapter transmits electricity to the L-type connector, the J-type connector and the H-type connector during an activating process. Therefore, different types of connectors/adapters can be installed during use of the connectors/adapters.

### CROSS REFERENCE TO RELATED APPLICATIONS

The present application claims the benefit of Chinese Patent Application No. 202510147080.1 filed on Feb. 10, 2025, the contents of which are incorporated herein by reference in their entirety.

### TECHNICAL FIELD

The present invention relates to the technical field of light installation equipment, and in particular to an interchangeable track light connector/adapter that fits to various single-circuit track systems.

### BACKGROUND TECHNOLOGY

An interchangeable connector/adapter usually includes key components such as an adapter body, engaging catches, and an adjustment mechanism. These components achieve fast and stable connection between the connector/adapter and different functional module equipment through precision design and manufacturing.

Applicant has found that the following problems exist in the existing technology: most of the current interchangeable connector/adapter can only be equipped with a single set of track adapter during use, so that it is needed to quickly find an appropriate track adapter for a lamp during replacement, resulting in increasing the time spent by the staff in the process of replacing the lamp, and reducing the practicality of the equipment. It is unable to meet the users' growing requirements.

### SUMMARY OF INVENTION

To overcome the disadvantages of the prior art, an object of the present invention is to provide an interchangeable track light connector/adapter that fits to various single-circuit track systems.

The technical solution adopted by the present invention is as follows: an interchangeable track light connector/adapter that fits to various single-circuit track systems, including a connector/adapter, grooves are opened on inner walls of the connector/adapter, two sets of positioning block adaptable to multiple sets of track adapter are mounted to the grooves of the connector/adapter, a lighting mechanism is mounted at a bottom end of each of the multiple sets of track adapter, multiple sets of track adapter base each have two sets of slot provided respectively on an inner wall of a left side and a right side of each of the multiple sets of track adapter base, and a positioning mechanism is slidably connected in the two sets of slot of each of the multiple sets of track adapter base.

Furthermore, the two sets of positioning block are respectively positioned and mounted on a left side and a right side of the connector/adapter; multiple sets of positioning groove are opened at inner portions of the two sets of positioning block; electrode plates are provided on inner sidewalls of the multiple sets of positioning groove of the two sets of positioning block; an L-type connector, a J-type connector and a H-type connector are respectively engaged with inner portions of the multiple sets of positioning groove of the two sets of positioning block; the L-type connector, the J-type connector and the H-type connector respectively include three sets of track adapter base; a set of first connecting spring tabs, a set of second connecting spring tabs and a set of third connecting spring tabs are respectively provided on an inner portion of the track adapter base of the L-type connector, the J-type connector and the H-type connector; and the set of first connecting spring tabs, the set of second connecting spring tabs and the set of third connecting spring tabs, on the sides far away from the track adapters, are respectively abutted against sides of the electrode plates at the inner portions of the two sets of positioning block.

Furthermore, inner portions of the three sets of track adapter base respectively include three sets of conducting spring tab clips, a bottom end of the L-type connector, the J-type connector and the H-type connector are respectively provided with three sets of spring tabs, a set of first conducting spring tabs, a set of second conducting spring tabs and a set of third conducting spring tabs are respectively provided on sides of the three sets of spring tabs, and positions of the three sets of conducting spring tab clips on the three sets of track adapter base are respectively located on moving paths of the three sets of spring tabs.

Furthermore, a material of the two sets of positioning block is an insulating material.

Furthermore, lower ends of the three sets of track adapter base are respectively provided with three sets of wire and three sets of hollow bearing, bottom portions of the three sets of wire are respectively opened with three recesses, and the three sets of hollow bearing are respectively inserted into the three recesses of the three sets of wire.

Furthermore, each lighting mechanism comprises a U-shaped fixing frame, a threaded hole is opened on a top surface of the U-shaped fixing frame, internal threads of the threaded hole of the U-shaped fixing frame are threadedly connected to external threads of the hollow bearing, two sets of groove are opened respectively on a left side and a right side of the U-shaped fixing frame, two sets of rotary block are dampingly and rotatably connected to the two sets of groove of the U-shaped fixing frame respectively, an LED lamp is mounted on adjacent sides of the two sets of rotary block, and an electrical connection is made between the wire and an access end of the LED lamp.

Furthermore, three sets of rubber pad are adhered to inner walls of the three sets of hollow bearing respectively, and inner portions of the three sets of rubber pad are respectively abutted against outer surfaces of the three sets of wire.

Furthermore, an indentation is opened on an upper surface of the U-shaped fixing frame, a gasket is provided in the indentation of the U-shaped fixing frame, and an upper surface of the gasket abuts against a lower surface of each track adapter base.

Furthermore, a positioning mechanism comprises two sets of sliding block, two sets of electric telescopic rod, and a U-shaped block; two sets of slot are opened on an inner wall of a left side and a right side of each track adapter base respectively; the two sets of sliding block are slidably connected in the two sets of slot of each track adapter base respectively; two sets of spring are provided on lower surfaces of the two sets of sliding block respectively; bottom ends of the two sets of spring are mounted on a bottom portion of the inner wall of each track adapter base respectively; two sets of groove are opened on upper surfaces of the two sets of sliding block respectively; two sets of fixing rod are mounted in the two sets of groove of the two sets of sliding block respectively; grooves and positioning recesses are opened on a left top surface and a right top surface of the L-type connector, the J-type connector and the H-type connector respectively; positions of the two sets of groove in the inner portion of the L-type connector, the J-type connector and the H-type connector are located on moving paths of the two sets of fixing rod; two sets of connecting block are provided on outer surfaces of the two sets of fixing rod respectively; two sets of contact switch are provided on upper surfaces of the two sets of sliding block respectively; positions of the two sets of contact switch are located on moving paths of the two sets of connecting block respectively; the two sets of electric telescopic rod are mounted on the bottom portion of the inner wall of each track adapter base respectively; the U-shaped block is slidably connected to inner portions of the positioning recesses of the L-type connector, the J-type connector and the H-type connector; output ends of the two sets of electric telescopic rod are both mounted on lower surfaces of the U-shaped block respectively; and electrical connections are made between the two sets of contact switch and control ends of the two sets of electric telescopic rod.

Furthermore, two sets of positioning groove are opened on a lower surface of each track adapter base, positions of the two sets of positioning groove of each track adapter base are located on moving paths of the two sets of fixing rod, two sets of positioning groove are opened on an upper surface of the U-shaped fixing frame, and positions of the two sets of positioning groove of the U-shaped fixing frame are located directly below the two sets of fixing rod.

To sum up, since the above technical solution is adopted, the beneficial effects of the present invention are:
1. In the present invention, by pushing the L-type connector, the J-type connector and the H-type connector, the L-type connector, the J-type connector and the H-type connector are slidably connected to the grooves between the two sets of positioning block respectively, so that a set of first connecting spring tabs, a set of second connecting spring tabs, and a set of third connecting spring tabs are in contact with the electrode plates in the grooves of the two sets of positioning block. The connector/adapter transmits electricity to the L-type connector, the J-type connector and the H-type connector during activating process, so that different types of connectors/adapters can be installed during use of the connectors/ adapters. Therefore, it only needs to replace the connector/adapter of a lamp to be compatible with different track systems, thereby improving the practicality of the product.
2. In the present invention, by pushing the L-type connector, the J-type connector or the H-type connector, the track adapter base is moved upward, so that the upper surfaces of two sets of fixing rod abut against the upper surfaces of the connector/adapter during the process of moving the track adapter base upward, and then two sets of fixing rod slide downward along the grooves of the L-type connector, the J-type connector or the H-type connector. The positions of two sets of contact switch are located on the moving paths of two sets of connecting block respectively, so that the two sets of fixing rod move downward during the process. The two sets of contact switch are triggered to start two sets of electric telescopic rod to push a U-shaped block upwards, and the U-shaped block is clamped inside the inner portion of the connector/adapter, so that a positioning mechanism limits the sliding position when the top of the L-type connector, the J-type connector or the H-type connector is mounted in the connector/adapter, thereby avoiding subsequent movement of the L-type connector, the J-type connector and the H-type connector when it is mounted inside the connector/adapter. This improves the stability of the L-type connector, the J-type connector and the H-type connector during use.

### DESCRIPTION OF THE DRAWINGS

FIG. 1 is a schematic diagram of the front structure of the present invention;

FIG. 2 is a cross-sectional view of the track adapter base of the present invention;

FIG. 3 is a schematic diagram of the top surface structure of the track adapter base of the present invention;

FIG. 4 is a schematic diagram of the front structure of the L-track adapter portion of the present invention;

FIG. 5 is a schematic diagram of the front structure of the L-track adapter of the present invention;

FIG. 6 is a schematic diagram of the front structure of the J-track adapter portion of the present invention;

FIG. 7 is a schematic diagram of the front structure of the J-track adapter of the present invention;

FIG. 8 is a schematic diagram of the front structure of the H-track adapter portion of the present invention;

FIG. 9 is a schematic diagram of the front structure of the H-track adapter of the present invention.

Reference symbols: 1. Connector/adapter; 2. Positioning block; 3. L-type connector; 301. First connecting spring tab; 302. First conducting spring tab; 4. Conducting spring tab clip; 5. J-type connector; 501. Second connecting spring tab; 502. Second conducting spring tab; 6. Hollow bearing; 7. Positioning mechanism; 701. U-shaped block; 702. Fixing rod; 703. Sliding block; 704. Connecting block; 705. Contact switch; 706. Electric telescopic rod; 707. Spring; 8. Wire; 9. Track adapter base; 10. Lighting mechanism; 1001. U-shaped fixing frame; 1002. Rotary block; 1003. LED lamp; 11. H-type connector; 1101. Third connecting spring tab; 1102. Third conducting spring tab; 12. Gasket; 13. Rubber pad.

### SPECIFIC EMBODIMENTS

In order to make the object, technical solution and advantages of the present invention clearer, the present invention will be further described in detail below in conjunction with the accompanying drawings and embodiments. It should be understood that the specific embodiments described herein are for the purpose of explaining the present invention only and are not intended to limit the present invention.

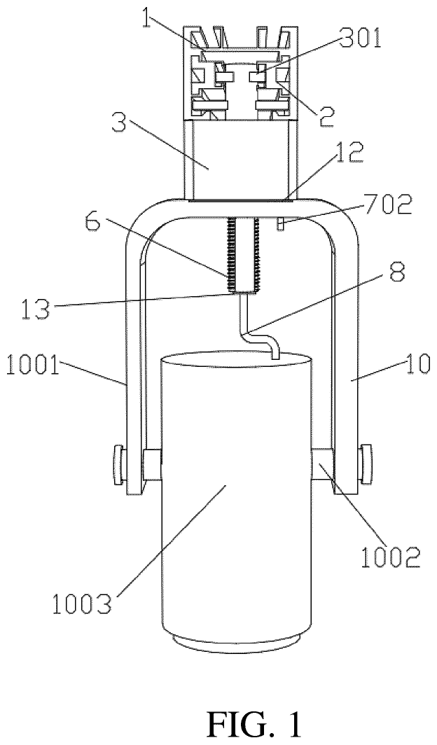

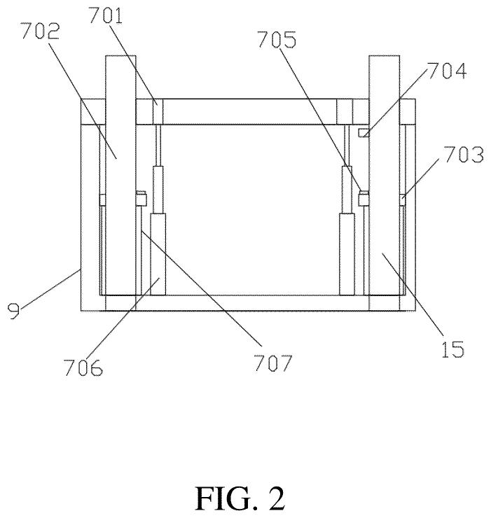

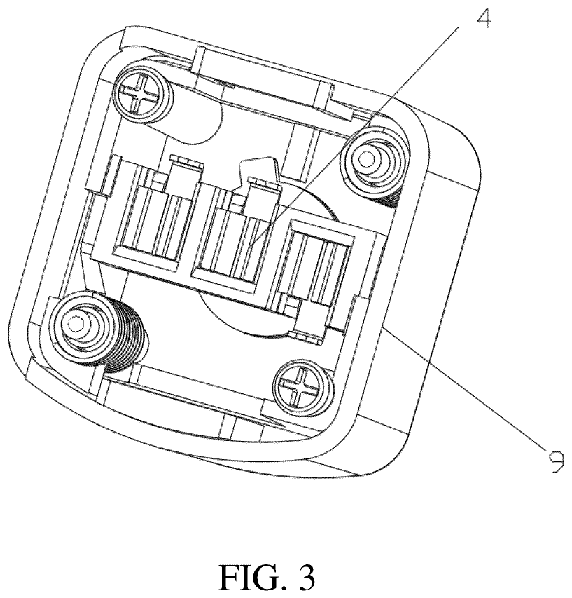

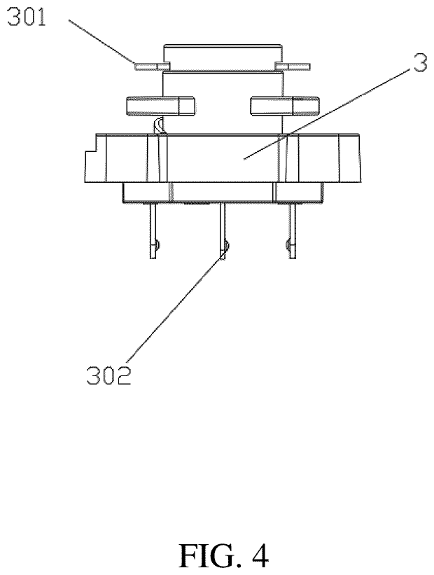

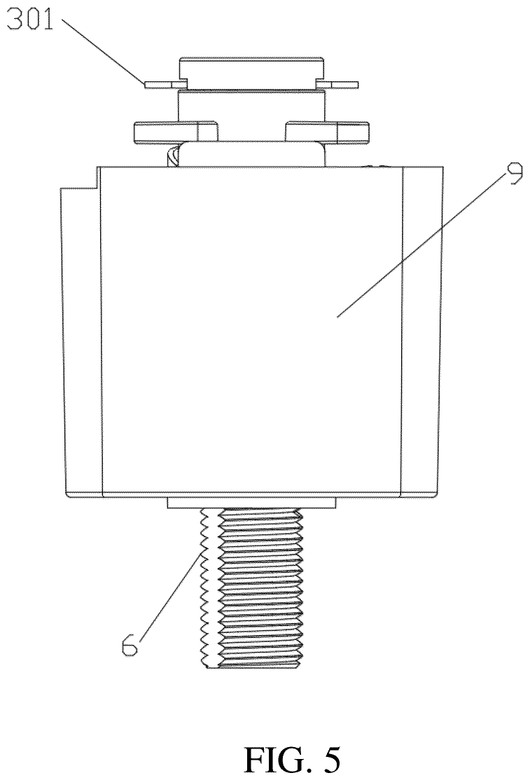

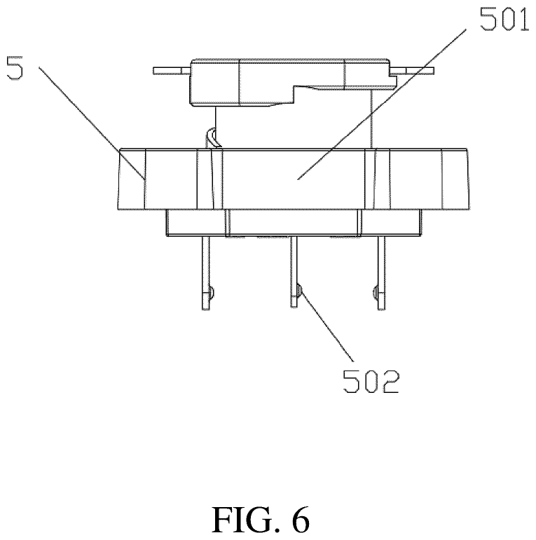

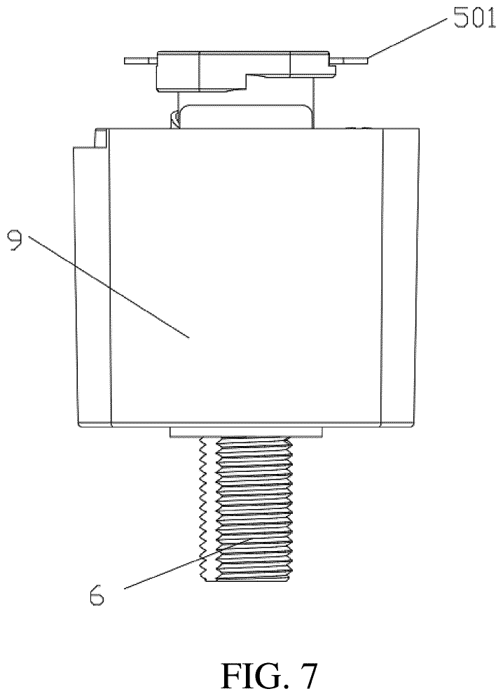

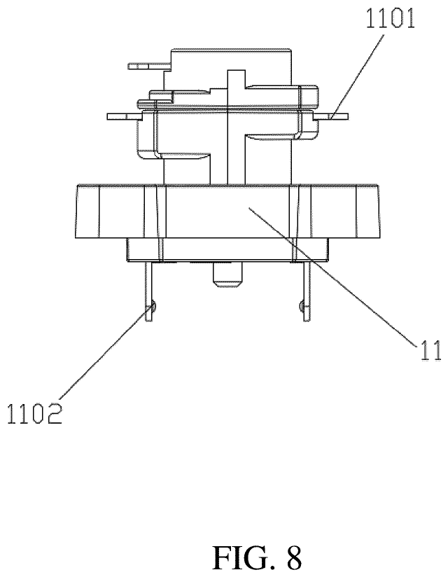

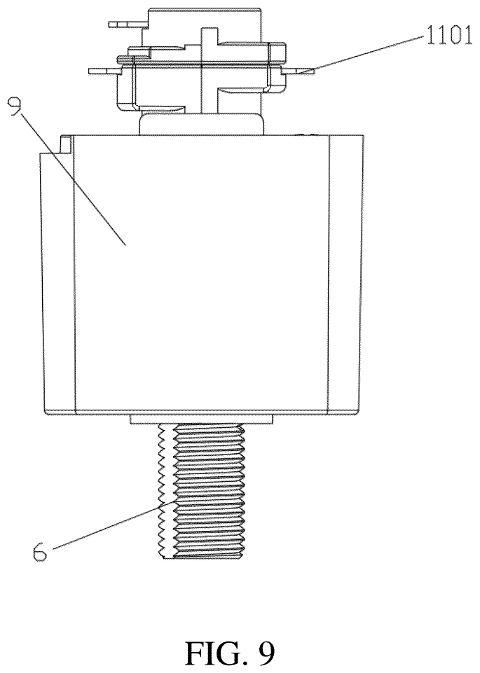

An interchangeable track light connector/adapter that fits to various single-circuit track systems, as shown in FIGS. 1 to 9, includes a connector/adapter 1, and grooves opened on inner walls of the connector/adapter 1. Two sets of positioning block 2 adaptable to multiple sets of track adapter are mounted to the grooves of the connector/adapter 1. A lighting mechanism 10 is mounted at a bottom end of each of the multiple sets of track adapter. By pushing an L-type connector 3, a J-type connector 5 and an H-type connector 11, the L-type connector 3, the J-type connector 5 and the H-type connector 11, are slidably connected to the grooves between the two sets of positioning block 2 respectively, so that the connector/adapter 1 transmits electricity to the L-type connector 3, the J-type connector 5 and the H-type connector 11 during an activating process. Different types of connectors/adapters 1 can be installed during use of the connectors/adapters 1. Therefore, it only needs to replace the connector/adapter 1 of the lamp to be compatible with different tracks, thereby improving the practicality of the product.

The two sets of positioning block 2 are respectively positioned and mounted on a left side and a right side of the connector/adapter 1. Multiple sets of positioning groove are opened at inner portions of the two sets of positioning block 2. Electrode plates are provided on inner sidewalls of the multiple sets of positioning groove of the two sets of positioning block 2. The L-type connector 3, the J-type connector 5 and the H-type connector 11 are respectively engaged with inner portions of the multiple sets of positioning groove of the two sets of positioning block 2. The L-type connector 3, the J-type connector 5 and the H-type connector 11 respectively include track adapter bases 9. A set of first connecting spring tabs 301, a set of second connecting spring tabs 501, and a set of third connecting spring tabs 1101 are respectively provided on the inner portion of the track adapter base 9 of the L-type connector 3, the J-type connector 5 and the H-type connector 11. The set of first connecting spring tabs 301, the set of second connecting spring tabs 501, and the set of third connecting spring tabs 1101, on the sides far away from the track adapters, are respectively abutted against the sides of the electrode plates at the inner portions of the two sets of positioning block 2. Specifically, by pushing the L-type connector 3, the J-type connector 5 and the H-type connector 11, the L-type connector 3, the J-type connector 5 and the H-type connector 11 are slidably connected to the grooves between the two sets of positioning block 2 respectively, so that the set of first connecting spring tabs 301, the set of second connecting spring tabs 501, and the set of third connecting spring tabs 1101 are in contact with the electrode plates in the grooves of the two sets of positioning block 2. The connector/adapter 1 transmits electricity to the L-type connector 3, the J-type connector 5 and the H-type connector 11 during the activating process, so that different types of connectors/adapters can be installed during use of the connector/adapter 1. Therefore, it only needs to replace the connector/adapter 1 of the lamp to be compatible with different tracks, thereby improving practicality of the product.

The inner portions of the track adapter bases 9 respectively include multiple sets of conducting spring tab clips 4. A bottom end of the L-type connector 3, the J-type connector 5 and the H-type connector 11 are respectively provided with multiple sets of spring tabs. A set of first conducting spring tabs 302, a set of second conducting spring tabs 502, and a set of third conducting spring tabs 1102 are respectively provided on the sides of the multiple sets of spring tabs. The positions of the multiple sets of conducting spring tab clips 4 on the track adapter bases are respectively located on the moving paths of the multiple sets of spring tabs. By pushing the top ends of the L-type connector 3, the J-type connector 5 and the H-type connector 11 and driving the multiple sets of spring tabs to move, the multiple sets of spring tabs are respectively engaged with the inner portions of the multiple sets of conducting spring tab clips 4 in the inner portions of the track adapter bases 9, enabling completion of electrical connection within the L-type connector 3, the J-type connector 5 and the H-type connector 11. Through the set of first conducting spring tabs 302, the set of second conducting spring tabs 502, and the set of third conducting spring tabs 1102 respectively provided at the outer ends of the multiple sets of spring tabs, the staff can determine whether the multiple sets of spring tabs and the multiple sets of conducting spring tab clips 4 are connected through the sound made when the set of first conducting spring tabs 302, the set of second conducting spring tabs 502, and the set of third conducting spring tabs 1102 are engaging with the inner portions of the multiple sets of conducting spring tab clips 4.

The material of the two sets of positioning block 2 is an insulating material. The two sets of positioning block 2 are made of insulating material in order to avoid the two sets of positioning block 2 from transmitting electricity to the connector/adapter 1 during use, thereby improving safety of the device during use.

The lower ends of the three sets of track adapter base 9 are respectively provided with three sets of wire 8 and three sets of hollow bearing 6. The bottom portions of the three sets of wire 8 are respectively opened with recesses. The three sets of hollow bearing 6 are respectively inserted into the three recesses of the three sets of wire 8. The three sets of wire 8 are arranged inside the three sets of hollow bearing 6, so that the three sets of hollow bearing 6 cover and protect the three sets of wire 8, thereby avoiding damage to the three sets of wire 8 during use, and improving the service life of the product.

The lighting mechanism 10 includes a U-shaped fixing frame 1001. A threaded hole is opened on a top surface of the U-shaped fixing frame 1001. The internal threads of the threaded hole of the U-shaped fixing frame 1001 are threadedly connected to external threads of the hollow bearing 6. Two sets of groove are opened respectively on a left side and a right side of the U-shaped fixing frame 1001. Two sets of rotary block 1002 are dampingly and rotatably connected to the two sets of groove of the U-shaped fixing frame 1001 respectively. An LED lamp 1003 is mounted on adjacent sides of the two sets of rotary block 1002. An electrical connection is made between the wire 8 and an access end of the LED lamp 1003. By pushing the LED lamp 1003, the two sets of rotary block 1002 are driven to rotate in the two sets of groove of the U-shaped fixing frame 1001, allowing a follow-up staff to quickly adjust the lighting path of the moving LED lamp 1003. This improves practicality of the lighting mechanism 10. By rotating the U-shaped fixing frame 1001, it drives the U-shaped fixing frame 1001 to rotate at the outer end of the hollow bearing 6, so that the follow-up staff can quickly disassemble the lighting mechanism 10 from the lower end of the connector/adapter 1. This enables the follow-up staff to disassemble the lighting mechanism 10 and the L-type connector 3, the J-type connector 5 or the H-type connector 11, thereby reducing the maintenance costs consumed by the lighting mechanism 10 when damaged, and thus improving practicality of the device.

Three sets of rubber pad 13 are adhered to inner walls of the three sets of hollow bearing 6 respectively. The inner portions of the three sets of rubber pad 13 are respectively abutted against outer surfaces of the three sets of wire 8. By positioning the rubber pad 13 between the wire 8 and the hollow bearing 6, the rubber pad 13 blocks the connecting surface of the wire 8 and the hollow bearing 6 so as to avoid the friction between the wire 8 and the bottom end opening of the hollow bearing 6 during swaying, which may result in damage to the wire 8.

An indentation is opened on an upper surface of the U-shaped fixing frame 1001. A gasket 12 is provided in the indentation of the U-shaped fixing frame 1001. An upper surface of the gasket 12 abuts against a lower surface of the track adapter base 9. By positioning the gasket 12 between the track adapter base 9 and the U-shaped fixing frame 1001, the gasket 12 limits the position of the U-shaped fixing frame 1001 during rotation of the hollow bearing 6, so as to avoid friction between the U-shaped fixing frame 1001 and the lower surface of the track adapter base 9 during rotation of the U-shaped fixing frame 1001, thereby improving the service life of the track adapter base 9.

A positioning mechanism 7 includes two sets of sliding block 703, two sets of electric telescopic rod 706, and a U-shaped block 701. Two sets of slot are opened respectively on an inner wall of a left side and a right side of each track adapter base 9. The positioning mechanism 7 is slidably connected in the two sets of slot of each track adapter base 9. The two sets of sliding block 703 are slidably connected in the two sets of slot of the track adapter base respectively. Two sets of spring 707 are provided on lower surfaces of the two sets of sliding block 703 respectively. The bottom ends of the two sets of spring 707 are mounted on a bottom portion of the inner wall of each track adapter base 9 respectively. Grooves are opened on upper surfaces of the two sets of sliding block 703 respectively. Two sets of fixing rod 702 are mounted in the grooves of the two sets of sliding block 703 respectively. Grooves and positioning recesses are opened on a left top surface and a right top surface of the L-type connector 3, the J-type connector 5 and the H-type connector 11 respectively. The positions of two sets of groove in an inner portion of the L-type connector 3, the J-type connector 5 and the H-type connector 11 are located on the moving paths of the two sets of fixing rod 702. Two sets of connecting block 704 are provided on outer surfaces of the two sets of fixing rod 702 respectively. Two sets of contact switch 705 are provided on upper surfaces of the two sets of sliding block 703 respectively. The positions of the two sets of contact switch 705 are located on the moving paths of the two sets of connecting block 704 respectively. The two sets of electric telescopic rod 706 are mounted on the bottom portion of the inner wall of the track adapter base 9 respectively. The U-shaped block 701 is slidably connected to inner portions of the positioning recesses of the L-type connector 3, the J-type connector 5 and the H-type connector 11. The output ends of the two sets of electric telescopic rod 706 are both mounted on lower surfaces of the U-shaped block 701 respectively. Electrical connections are made between the two sets of contact switch 705 and control ends of the two sets of electric telescopic rod 706.

Specifically, when the top end of the L-type connector 3, the J-type connector 5 or the H-type connector 11 is installed inside the connector/adapter 1, pushing of the L-type connector 3, the J-type connector 5 or the H-type connector 11 drives the track adapter base 9 to move upward, so that the upper surfaces of the two sets of fixing rod 702 abut on the upper surface of the connector/adapter 1 during the upward movement. The upper surfaces of the two sets of fixing rod 702 abut on the upper surface of the connector/adapter 1, and then the two sets of fixing rod 702 slides downward along the grooves of the L-type connector 3, the J-type connector 5 or the H-type connector 11, and then the positions of the two sets of contact switch 705 are respectively located on the movement paths of the two sets of connecting block 704. During downward movement of the two sets of fixing rod 702, the two sets of contact switch 705 are triggered to start the two sets of electric telescopic rod 706 to push the U-shaped block 701 upward. The U-shaped block 701 is then clamped in the inner portion of the connector/adapter 1, thereby limiting the sliding position when the top end of the L-type connector 3, the J-type connector 5 or the H-type connector 11 is installed in the connector/adapter 1, so as to avoid movement caused by the L-type connector 3, the J-type connector 5 or the H-type connector 11 when they are installed in the connector/adapter 1. This improves the stability of the L-type connector 3, the J-type connector 5 and the H-type connector 11 during use.

Two sets of positioning groove are opened on a lower surface of the track adapter base 9. The positions of the two sets of positioning groove of the track adapter base 9 are located on the moving paths of the two sets of fixing rod 702. Two sets of positioning groove are opened on an upper surface of the U-shaped fixing frame 1001. The positions of the two sets of positioning groove of the U-shaped fixing frame 1001 are located directly below the two sets of fixing rod 702. The two sets of fixing rod 702 are moved downward when they are pressed, so that the bottom ends of the two sets of fixing rods 702 are inserted through the two sets of positioning groove of the U-shaped fixing frame 1001 during movement. The positioning mechanism 7 restricts the position of the U-shaped fixing frame 1001 at the outer end of the hollow bearing 6, so as to avoid rotation of the U-shaped fixing frame 1001 at the outer end of the hollow bearing 6 during use, thereby improving the stability of the process of adjusting and moving the LED lamp 1003 by a follow-up staff.

By pushing the L-type connector 3, the J-type connector 5 and the H-type connector 11, the L-type connector 3, the J-type connector 5 and the H-type connector 11 are slidably connected to the grooves between the two sets of positioning block 2, so that the set of first connecting spring tabs 301, the set of second connecting spring tabs 501, and the set of third connecting spring tabs 1101 are in contact with the electrode plates inside the grooves of the two sets of positioning block 2. The connector/adapter 1 transmits power to the L-type connector 3, the J-type connector 5 and the H-type connector 11 during the activating process. In the process of using the connector/adapter 1, different types of connectors/adapters 1 can be installed, so that it only needs to replace the connector/adapter 1 of a lamp to be compatible with different tracks. By pushing the tops of the L-type connector 3, the J-type connector 5 and the H-type connector 11, multiple sets of spring tabs are moved, and the multiple sets of spring tabs are respectively clamped into the inner portions of the multiple sets of conducting spring tab clips 4 in the track adapter bases 9, so that the L-type connector 3, the J-type connector 5 and the H-type connector 11 are electrically connected.

At the same time, by pushing the L-type connector 3, the J-type connector 5 or the H-type connector 11 and moving the track adapter base 9 upward, the upper surfaces of the two sets of fixing rod 702 abut against the upper surface of the connector/adapter 1 during the process of moving the track adapter base 9 upward. The two sets of fixing rod 702 slide downward along the grooves of the L-type connector 3, the J-type connector 5 or the H-type connector 11. The two sets of contact switch 705 are positioned on the movement paths of the two sets of connecting block 704 respectively. During downward movement of the two sets of fixing rod 702, the two sets of contact switch 705 are triggered to start the two sets of electric telescopic rod 706 to push the U-shaped block 701 upward. The U-shaped block 701 is clamped into the inner portion of the connector/adapter 1, thereby causing the positioning mechanism 7 to limit the sliding position when the top end of the L-type connector 3, the J-type connector 5 or the H-type connector 11 is installed in the connector/adapter 1. This avoids subsequent movement when the L-type connector 3, the J-type connector 5 or the H-type connector 11 are installed in the connector/adapter 1.

The above are only preferred embodiments of the present invention and are not intended to limit the present invention. Any modification, equivalent replacement and improvement made within the spirit and principles of the present invention shall be included within the scope of protection of the present invention.

What is claimed is:

1. An interchangeable track light connector/adapter that fits to various single-circuit track systems, comprising a connector/adapter, characterized in that: grooves are opened on inner walls of the connector/adapter, two sets of positioning block adaptable to multiple sets of track adapter are mounted to the grooves of the connector/adapter, a lighting mechanism is mounted at a bottom end of each of the multiple sets of track adapter, multiple sets of track adapter base each have two sets of slot provided respectively on an inner wall of a left side and a right side of each of the multiple sets of track adapter base, and a positioning mechanism is slidably connected in the two sets of slot of each of the multiple sets of track adapter base.

2. The interchangeable track light connector/adapter that fits to various single-circuit track systems according to claim 1, characterized in that: the two sets of positioning block are respectively positioned and mounted on a left side and a right side of the connector/adapter; multiple sets of positioning groove are opened at inner portions of the two sets of positioning block; electrode plates are provided on inner sidewalls of the multiple sets of positioning groove of the two sets of positioning block; an L-type connector, a J-type connector and a H-type connector are respectively engaged with inner portions of the multiple sets of positioning groove of the two sets of positioning block; the L-type connector, the J-type connector and the H-type connector respectively include three sets of track adapter base; a set of first connecting spring tabs, a set of second connecting spring tabs and a set of third connecting spring tabs are respectively provided on an inner portion of the track adapter base of the L-type connector, the J-type connector and the H-type connector; and the set of first connecting spring tabs, the set of second connecting spring tabs and the set of third connecting spring tabs, on the sides far away from the track adapters, are respectively abutted against sides of the electrode plates at the inner portions of the two sets of positioning block.

3. The interchangeable track light connector/adapter that fits to various single-circuit track systems according to claim 2, characterized in that: inner portions of the three sets of track adapter base respectively include three sets of conducting spring tab clips, a bottom end of the L-type connector, the J-type connector and the H-type connector are respectively provided with three sets of spring tabs, a set of first conducting spring tabs, a set of second conducting spring tabs and a set of third conducting spring tabs are respectively provided on sides of the three sets of spring tabs, and positions of the three sets of conducting spring tab clips on the three sets of track adapter base are respectively located on moving paths of the three sets of spring tabs.

4. The interchangeable track light connector/adapter that fits to various single-circuit track systems according to claim 1, characterized in that: a material of the two sets of positioning block is an insulating material.

5. The interchangeable track light connector/adapter that fits to various single-circuit track systems according to claim 2, characterized in that: lower ends of the three sets of track adapter base are respectively provided with three sets of wire and three sets of hollow bearing, bottom portions of the three sets of wire are respectively opened with three recesses, and the three sets of hollow bearing are respectively inserted into the three recesses of the three sets of wire.

6. The interchangeable track light connector/adapter that fits to various single-circuit track systems according to claim 5, characterized in that: each lighting mechanism comprises a U-shaped fixing frame, a threaded hole is opened on a top surface of the U-shaped fixing frame, internal threads of the threaded hole of the U-shaped fixing frame are threadedly connected to external threads of the hollow bearing, two sets of groove are opened respectively on a left side and a right side of the U-shaped fixing frame, two sets of rotary block are dampingly and rotatably connected to the two sets of groove of the U-shaped fixing frame respectively, an LED lamp is mounted on adjacent sides of the two sets of rotary block, and an electrical connection is made between the wire and an access end of the LED lamp.

7. The interchangeable track light connector/adapter that fits to various single-circuit track systems according to claim 5, characterized in that: three sets of rubber pad are adhered to inner walls of the three sets of hollow bearing respectively, and inner portions of the three sets of rubber pad are respectively abutted against outer surfaces of the three sets of wire.

8. The interchangeable track light connector/adapter that fits to various single-circuit track systems according to claim 6, characterized in that: an indentation is opened on an upper surface of the U-shaped fixing frame, a gasket is provided in the indentation of the U-shaped fixing frame, and an upper surface of the gasket abuts against a lower surface of each track adapter base.

9. The interchangeable track light connector/adapter that fits to various single-circuit track systems according to claim 6, characterized in that: each positioning mechanism comprises two sets of sliding block, two sets of electric telescopic rod, and a U-shaped block; the two sets of slot are opened on the inner wall of the left side and the right side of each track adapter base respectively; the two sets of sliding block are slidably connected in the two sets of slot of each track adapter base respectively; two sets of spring are provided on lower surfaces of the two sets of sliding block respectively; bottom ends of the two sets of spring are mounted on a bottom portion of the inner wall of each track adapter base respectively; two sets of groove are opened on upper surfaces of the two sets of sliding block respectively; two sets of fixing rod are mounted in the two sets of groove of the two sets of sliding block respectively; grooves and positioning recesses are opened on a left top surface and a right top surface of the L-type connector, the J-type connector and the H-type connector respectively; positions of the two sets of groove in the inner portion of the L-type connector, the J-type connector and the H-type connector are located on moving paths of the two sets of fixing rod; two sets of connecting block are provided on outer surfaces of the two sets of fixing rod respectively; two sets of contact switch are provided on upper surfaces of the two sets of sliding block respectively; positions of the two sets of contact switch are located on moving paths of the two sets of connecting block respectively; the two sets of electric telescopic rod are mounted on the bottom portion of the inner wall of each track adapter base respectively; the U-shaped block is slidably connected to inner portions of the positioning recesses of the L-type connector, the J-type connector and the H-type connector; output ends of the two sets of electric telescopic rod are both mounted on lower surfaces of the U-shaped block respectively; and electrical connections are made between the two sets of contact switch and control ends of the two sets of electric telescopic rod.

10. The interchangeable track light connector/adapter that fits to various single-circuit track systems according to claim 9, characterized in that: two sets of positioning groove are opened on a lower surface of each track adapter base, positions of the two sets of positioning groove of each track adapter base are located on moving paths of the two sets of fixing rod, two sets of positioning groove are opened on an upper surface of the U-shaped fixing frame, and positions of the two sets of positioning groove of the U-shaped fixing frame are located directly below the two sets of fixing rod.
